(19) United States
(12) Patent Application Publication
(10) Pub. No.: US 2016/0283522 A1
(43) Pub. Date: Sep. 29, 2016

(54) MATCHING UNTAGGED DATA SOURCES TO UNTAGGED DATA ANALYSIS APPLICATIONS

(71) Applicant: INTERNATIONAL BUSINESS MACHINES CORPORATION, Armonk, NY (US)

(72) Inventors: Keith W. Grueneberg, Stewart Manor, NY (US); Bong Jun Ko, Harrington Park, NJ (US); Jorge J. Ortiz, New York, NY (US); Theodoros Salonidis, Cambridge, MA (US); Rahul Urgaonkar, Rye, NY (US); Dinesh C. Verma, Mount Kisco, NY (US); Xiping Wang, Scarsdale, NY (US)

(21) Appl. No.: 14/743,130

(22) Filed: Jun. 18, 2015

Related U.S. Application Data
(63) Continuation of application No. 14/667,320, filed on Mar. 24, 2015.

(51) Int. Cl. G06F 17/30

(52) U.S. Cl. CPC G06F 17/30289; G06F 17/30321

(57) ABSTRACT

A method and system are provided. The method includes identifying a set of applications compatible with a set of data. The applications and the data are untagged by corresponding metadata. The identifying step includes executing, by an execution platform, at least some of the applications in the set against at least some of the data in the set. The identifying step further includes analyzing, by a log analyzer, execution logs for executions of the at least some of the applications against the at least some of the data. The identifying step also includes indicating, by the log analyzer, a compatibility of the at least some of the applications to the at least some of the data by detecting compatibility relevant errors using the execution logs.

### CROSS-REFERENCE TO RELATED APPLICATIONS

This application is a Continuation application of co-pending U.S. patent application Ser. No. 14/667,320 filed on Mar. 24, 2015, incorporated herein by reference in its entirety.

### GOVERNMENT RIGHTS

This invention was made with Government support under Contract No.: W911NF-06-3-0001 awarded by the Army Research Office (ARO). The Government has certain rights in this invention.

### BACKGROUND

1. Technical Field

The present invention relates generally to information processing and, in particular, to matching untagged data sources to untagged data analysis applications.

2. Description of the Related Art

Data analysis applications and algorithms are generally written with the assumption that the data sources are organized in certain formats (e.g., database schema, particular key-value structures, and so forth). For the analysis to be able to consume a given (arbitrary) data set, the first step is to analyze the data set to determine whether the data set is compatible with the given analysis job. If it is not the case, then some sort of data transformation processes, namely, Extraction, Transformation, and Load, (ETL), need to be carried out before the analysis job can be performed on the data set. Although the advances in the data analysis techniques of various kinds are constantly made in the area of, for example, data mining, big data analysis, machine learning, and so forth, these pre-processing steps of the data analysis still remains time-consuming and in most cases are quite labor-intensive. There are tools that help ease the developers of the analytics application and the data analysts from such pre-processing tasks by analyzing the data set, profiling/discovering the data formats, and transforming the formats in automated fashions. However, their utility still remains domain-specific and the accuracy of the results is typically not good enough to fully eliminate the human involvement, not to mention the cost involved in developing such solutions.

### SUMMARY

According to an aspect of the present principles, a method is provided. The method includes identifying a set of applications compatible with a set of data. The applications and the data are untagged by corresponding metadata. The identifying step includes executing, by an execution platform, at least some of the applications in the set against at least some of the data in the set. The identifying step further includes analyzing, by a log analyzer, execution logs for executions of the at least some of the applications against the at least some of the data. The identifying step also includes indicating, by the log analyzer, a compatibility of the at least some of the applications to the at least some of the data by detecting compatibility relevant errors using the execution logs.

According to another aspect of the present principles, a system is provided. The system includes an execution platform for executing at least some applications from a set of applications against at least some data from a set of data. The applications and the data are untagged by corresponding metadata. The system further includes a log analyzer for analyzing execution logs for executions of the at least some applications against the at least some data, and indicating a compatibility of the at least some applications to the at least some data by detecting compatibility relevant errors using the execution logs.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows an exemplary processing system 100 to which the present principles may be applied, in accordance with an embodiment of the present principles;

FIG. 2 shows an exemplary system 200 for matching untagged data sources to untagged data analysis applications, in accordance with an embodiment of the present principles;

FIG. 3 shows an exemplary method 300 for matching untagged data sources to untagged data analysis applications, in accordance with an embodiment of the present principles;

FIG. 4 shows another exemplary method 400 for matching untagged data sources to untagged data analysis applications, in accordance with an embodiment of the present principles;

FIG. 5 shows yet another exemplary method 500 for matching untagged data sources to untagged data analysis applications, in accordance with an embodiment of the present principles;

FIG. 6 shows still another exemplary method 600 for matching untagged data sources to untagged data analysis applications, in accordance with an embodiment of the present principles;

FIG. 7 shows a method 700 for determining whether or not data is compliant with one or more analytic solutions, in accordance with various embodiments of the present principles;

FIG. 8 shows another method 800 for determining whether or not data is compliant with one or more analytic solutions, in accordance with various embodiments of the present principles;

FIG. 9 shows yet another method 900 for determining whether or not data is compliant with one or more analytic solutions, in accordance with various embodiments of the present principles;

FIG. 10 shows an exemplary cloud computing node 1010, in accordance with an embodiment of the present principles;

FIG. 11 shows an exemplary cloud computing environment 1150, in accordance with an embodiment of the present principles; and

FIG. 12 shows exemplary abstraction model layers, in accordance with an embodiment of the present principles.

### DETAILED DESCRIPTION OF PREFERRED EMBODIMENTS

The present principles are directed to matching untagged data sources to untagged data analysis applications.

In an embodiment, a method is provided that identifies analytics solutions that match a given data source, from a collection of analytics solutions, by taking advantage of cloud computing technologies. The method does not assume the availability of pre-defined meta-information about the analytics solutions or the data source for the matching task, nor does it require the pre-processing tasks of analyzing, profiling, or discovering the data source.

Thus, the present principles advantageously solve the problem of matching untagged analytical solutions to untagged data sources. In an embodiment, the present principles involve testing a collection of candidate analytical solutions against a given data source to quickly determine whether each analytical solution is capable of consuming the given data source without generating serious problems. The matching process is carried out either sequentially or in parallel, by bringing up each analytics solution from a repository of solution images, using cloud technologies, and by analyzing the log information generated by the analytics solution to find out whether there is any severe errors or exceptions related to the data access or analysis process, when the analytics solution is executed upon a subset (or “samples”) of the data set. The results of the log analysis are sent to an analytics finder module to record the results of the matching process.

In an embodiment, any applications that are indicated to have an incompatible status are prevented from being executed against the same data or similar data for which the indication is provided without modification intended to overcome the incompatible status. In this way, computer crashes due to, and wasteful consumption of computing resources by, incompatible applications can be avoided.

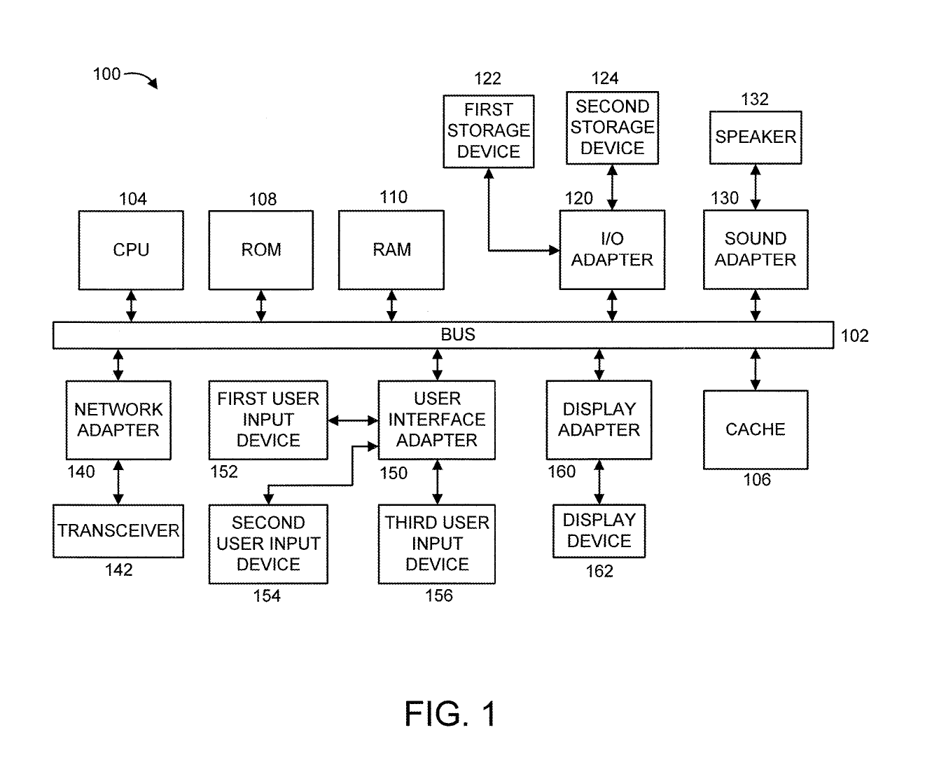

FIG. 1 shows an exemplary processing system 100 to which the present principles may be applied, in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

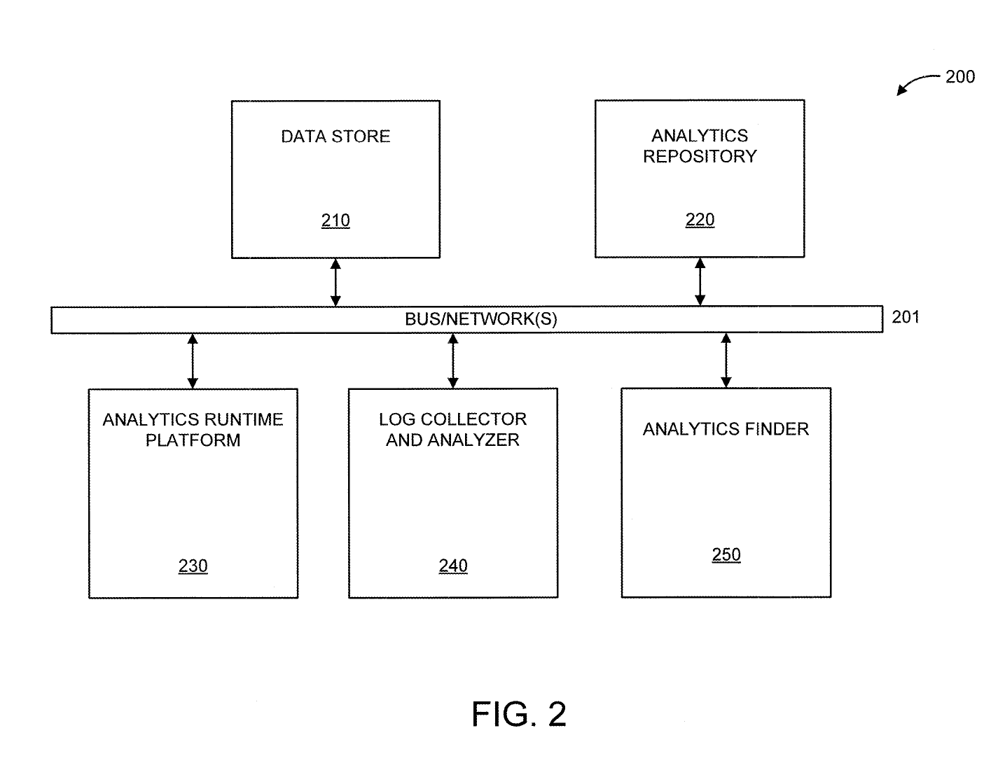

Moreover, it is to be appreciated that system 200 described below with respect to FIG. 2 is a system for implementing respective embodiments of the present principles. Part or all of processing system 100 may be implemented in one or more of the elements of system 200.

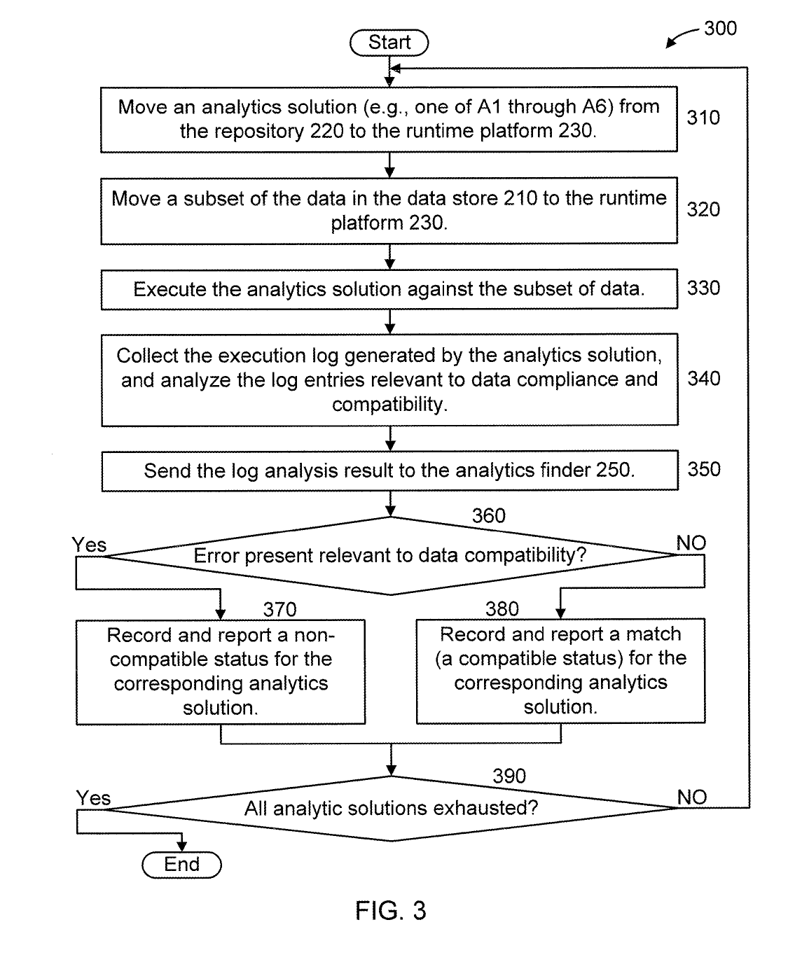

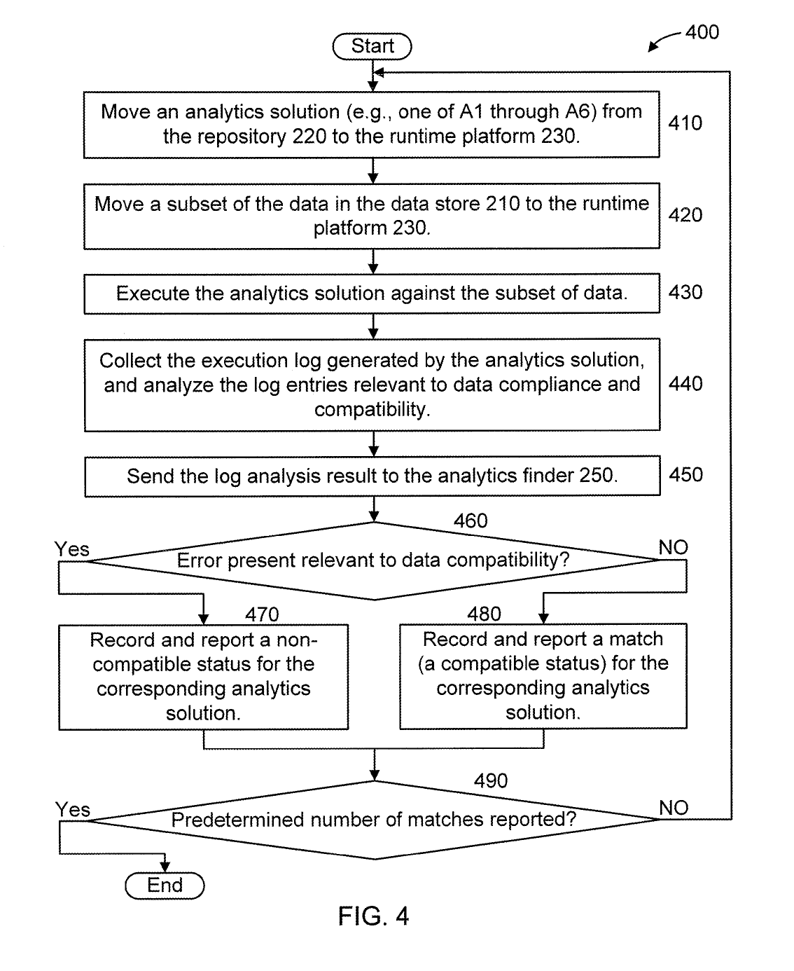

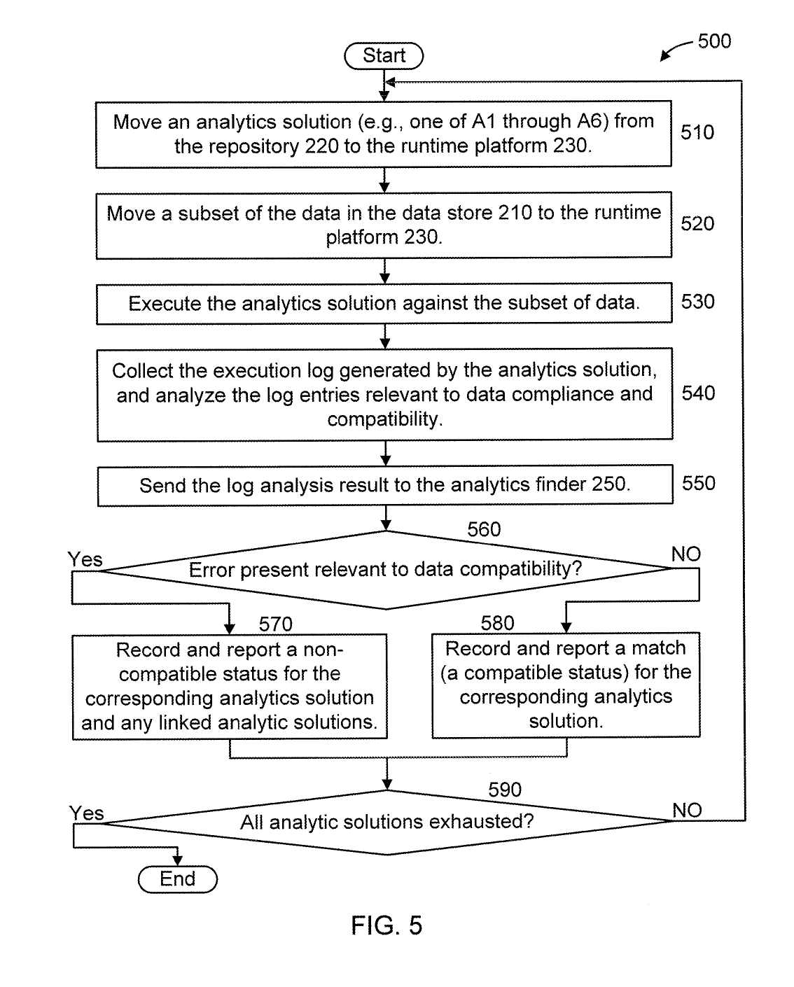

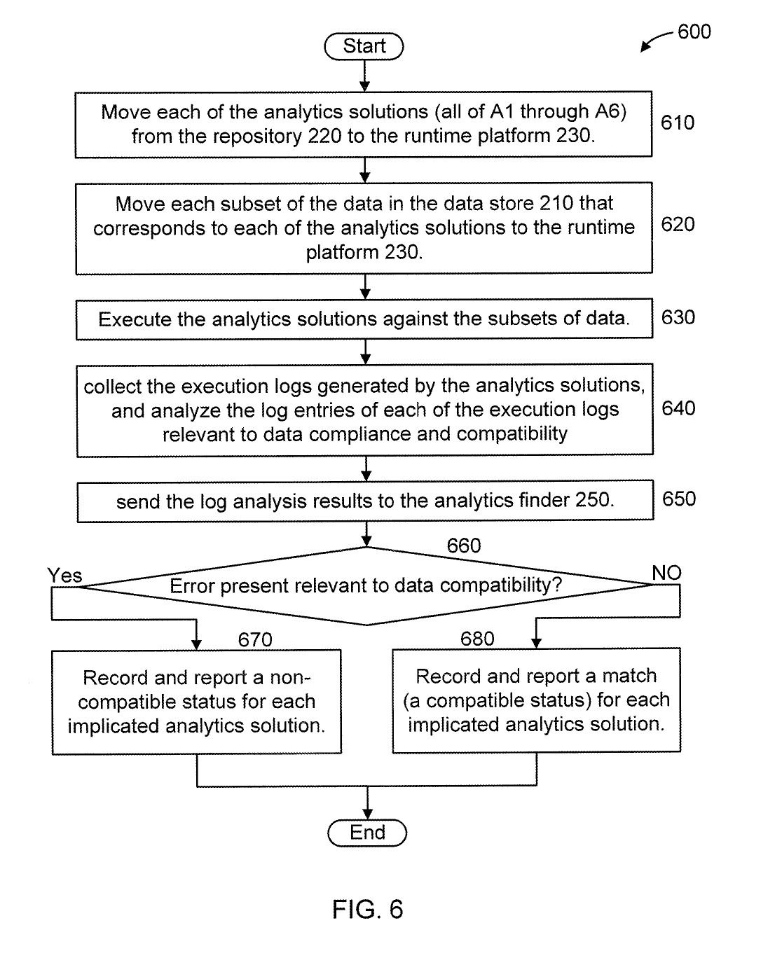

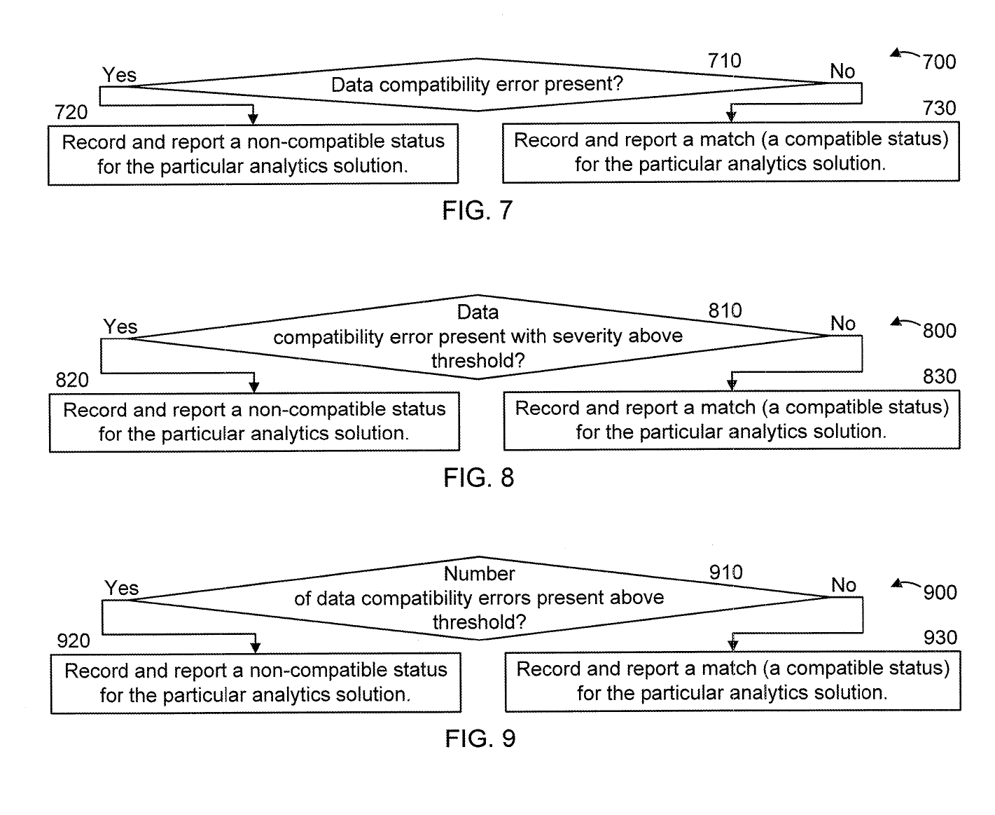

Further, it is to be appreciated that processing system 100 may perform at least part of the method described herein including, for example, at least part of method 300 of FIG. 3 and/or at least part of method 400 of FIG. 4 and/or at least part of method 500 of FIG. 5 and/or at least part of method 600 of FIG. 6 and/or at least part of method 700 of FIG. 7 and/or at least part of method 800 of FIG. 8 and/or at least part of method 900 of FIG. 9. Similarly, part or all of system 200 may be used to perform at least part of method 300 of FIG. 3 and/or at least part of method 400 of FIG. 4 and/or at least part of method 500 of FIG. 5 and/or at least part of method 600 of FIG. 6 and/or at least part of method 700 of FIG. 7 and/or at least part of method 800 of FIG. 8 and/or at least part of method 900 of FIG. 9.

FIG. 2 shows an exemplary system 200 for matching untagged data sources to untagged data analysis applications, in accordance with an embodiment of the present principles.

The system 200 includes a data store 210, an analytics repository 220, an analytics runtime platform 230, a log collector and analyzer 240, and an analytics finder 250.

The data store 210 stores a set of data. The data in the set is untagged. That is, the data in the set does not include and are not provided with meta-information or metadata. Moreover, use of the data in the set does not require the pre-processing tasks of analyzing, profiling, or discovering the data source for the data.

The analytics repository 220 stores a set of candidate analytics (also referred to herein as “analytic solutions”). The analytics solutions in the set are untagged. That is, the analytics solutions in the set do not include and are not provided with meta-information or metadata.

In an embodiment, the set of data stored in the data store 210 includes respective data portions to be tested against (executed by) respective analytics solutions in a set of candidate analytic solutions stored in the analytics repository 220.

In an embodiment, the set of analytic solutions are a set of applications that interface with and process the data. For example, such applications can be data analysis applications. Hence, lack of compatibility between the respective data portions and the respective analytic solutions can involve compatibility issues relating to interfacing with the data in the first place, processing the data, and any other actions between the respective data portions and respective analytic solutions as readily appreciated by one of ordinary skill in the art. For example, with respect to processing the data, compatibility of the data with respect to a particular analysis (e.g., type, goal, etc.) can be evaluated. Other compatibility issues include, but are not limited to, interfacing issues where the data format may not be compatible with the analytics function, incompatible fields (name and/or type of the fields) in data versus analytics, database table and/or column expected by the analytics but not existing in the database, and so forth.

Of course, it is to be appreciated that the preceding compatibility issues are merely illustrative and, thus, other types of compatibility issues can also be checked for in accordance with the teachings of the present principles, while maintaining the spirit of the present principles.

The analytics runtime platform 230 executes the analytics solutions against data extracted from the data store 210.

The log collector and analyzer 240 collects the execution logs from the executed analysis solution and analyzes the errors and exceptions (collectively referred to herein as “errors”) in the execution logs. Identification of errors and exceptions in the execution logs can include looking for predefined log messages corresponding to errors, exceptions, or warnings, such as structured query language (SQL) errors regarding inaccessible database/table/fields, or data type mismatches, analyzing the sequence of steps executed against expected normal behavior, system level errors and exceptions such as related to memory access, out of bound arrays, and so forth.

The analytics finder 250 schedules the matching processes, for example, by bringing up the analytics solutions from the analytics repository 220 for execution by the analytics runtime platform 230.

Regarding system 200, the same represents an exemplary configuration for implementing the present principles. It is to be appreciated that various different runtime execution environments, corresponding forms of the analytics solutions, and methods to deploy and execute them, can be used in accordance with the teachings of the present principles, while maintaining the spirit of the present principles. For example, each solution can be packaged into a virtual machine (or a set of virtual machines), and a hypervisor or other virtual machine execution platform can be used as the runtime execution environment. Alternatively, and/or in supplement to the preceding approach, each solution can be provided as an application artifact (e.g., a java application) and deployed on an application runtime platform (e.g., Java virtual machine (JVM)).

In the embodiment shown in FIG. 2, the elements thereof are interconnected by a bus 201/network(s). However, in other embodiments, other types of connections can also be used. Moreover, in an embodiment, at least one of the elements of system 200 is processor-based. Further, while one or more elements may be shown as separate elements, in other embodiments, these elements can be combined as one element. Additionally, one or more elements of system 200 may be incorporated in a distributed fashion in one or more separate devices. For example, different elements can be located at different locations. Also, more than one instance of any of the elements can be used in an embodiment of the present principles. Moreover, system 200 can be implemented using cloud technology and configurations as described herein.

These and other variations of the elements of system 200 are readily determined by one of ordinary skill in the art, given the teachings of the present principles provided herein, while maintaining the spirit of the present principles.

FIGS. 3-6 show various methods for matching untagged data sources to untagged data analysis applications, in accordance with various embodiments of the present principles. Thus, for example, in the examples of FIGS. 3-6, the data sources and the data analysis applications are not tagged with their corresponding metadata. The method 300 of FIG. 3 serially processes the analytic solutions (applications) and terminates once all of the analytic solutions have been exhausted (analyzed). The method 400 of FIG. 4 serially processes the analytic solutions and terminates when a predetermined number matches exists between analytic solutions and corresponding data (to be accessed and processed thereby). The method 500 serially processes each of the analytic solutions, where some are linked such that a determination of non-compatible status for a particular analytic solution will result in the same status for analytic solutions linked thereto, thus increasing overall efficiency while reducing resource (e.g., processing resource, etc.) consumption. The method 600 of FIG. 6 processes each of the analytic solutions in parallel to concurrently determine which of the analytic solutions are compliant and/or non-compliant.

FIG. 3 shows an exemplary method 300 for matching untagged data sources to untagged data analysis applications, in accordance with an embodiment of the present principles.

At step 310, move an analytics solution (e.g., one of A1 through A6) from the repository 220 to the runtime platform 230.

At step 320, move a subset of the data in the data store 210 to the runtime platform 230.

At step 330, execute the analytics solution against the subset of data.

At step 340, collect the execution log generated by the analytics solution, and analyze the log entries relevant to data compliance and compatibility.

At step 350, send the log analysis result to the analytics finder 250.

At step 360, determine, using the log analysis result, whether or not there is any error present that is relevant to data compatibility (data access and data processing). If so, then the method proceeds to step 370. Otherwise, the method proceeds to step 380.

At step 370, record and report a non-compatible status for the corresponding analytics solution.

At step 380, record and report a match (a compatible status) for the corresponding analytics solution.

At step 390, determine whether or not all analytic solutions in the repository have been exhausted (analyzed). If so, them the method is terminated. Otherwise, the method returns to step 310.

FIG. 4 shows another exemplary method 400 for matching untagged data sources to untagged data analysis applications, in accordance with an embodiment of the present principles.

At step 410, move an analytics solution (e.g., one of A1 through A6) from the repository 220 to the runtime platform 230.

At step 420, move a subset of the data in the data store 210 to the runtime platform 230.

At step 430, execute the analytics solution against the subset of data.

At step 440, collect the execution log generated by the analytics solution, and analyze the log entries relevant to data compliance and compatibility.

At step 450, send the log analysis result to the analytics finder 250.

At step 460, determine, using the log analysis result, whether or not there is any error present that is relevant to data compatibility (data access and data processing). If so, then the method proceeds to step 470. Otherwise, the method proceeds to step 480.

At step 470, record and report a non-compatible status for the corresponding analytics solution.

At step 480, record and report a match (a compatible status) for the corresponding analytics solution.

At step 490, determine whether or not a predetermined number of matches have been reported in step 480. If so, then the method is terminated. Otherwise, the method returns to step 410.

It is to be appreciated that step 490 can terminate the method 400 upon the finding of a first match (i.e., the predetermined number of matches is set equal to one), or some other number of matches depending upon the implementation.

An alternate method of the present principles (as shown in FIG. 5) involves utilizing a pre-defined relationship between the analytics solutions in the analytics repository 220, so that when a mismatch of a particular analytics solution is detected, other related analytics solutions are immediately declared for mismatch as well, thereby speeding up the matching process. More specifically, before executing the analytics solution for matching test, the solutions in the repositories are linked between each other if they share common criteria (e.g., common error symptoms that will make them not applicable to the data source). Then when a solution is detected to be incompatible to the data source, all the analytics solutions linked to it are declared to be incompatible as well, and not considered in the matching process. Linkage across the analytics solutions can be made either using implicit information, such as product numbers, version/revision number of the same analytics solutions, and similarity in the functional descriptions, or explicit meta information describing the ontological structure of a set of analytics solutions that is provided by the analytics solution provider or developer. Note that the second type of the meta information refers to what indicates the relationship between the analytics solutions, not their semantic or syntactic compatibility to the data.

FIG. 5 shows yet another exemplary method 500 for matching untagged data sources to untagged data analysis applications, in accordance with an embodiment of the present principles. In the embodiment of FIG. 5, at least some of the analytic solutions are linked. Such linking can be determined based on one or more criterion including, but not limited to, similarly of data access, similarity of data processing, similarity of previously encountered errors or expected errors, and so forth. The preceding criteria are merely illustrative and, thus, other criteria can also be used in accordance with the teachings of the present principles, while maintaining the spirit of the present principles.

At step 510, move an analytics solution (e.g., one of A1 through A6) from the repository 220 to the runtime platform 230.

At step 520, move a subset of the data in the data store 210 to the runtime platform 230.

At step 530, execute the analytics solution against the subset of data.

At step 540, collect the execution log generated by the analytics solution, and analyze the log entries relevant to data compliance and compatibility.

At step 550, send the log analysis result to the analytics finder 250.

At step 560, determine, using the log analysis result, whether or not there is any error present that is relevant to data compatibility (data access and data processing). If so, then the method proceeds to step 570. Otherwise, the method proceeds to step 580.

At step 570, record and report a non-compatible status for the corresponding analytics solution and any linked analytic solutions.

At step 580, record and report a match (a compatible status) for the corresponding analytics solution.

At step 590, determine whether or not all analytic solutions in the repository have been exhausted (analyzed). If so, then the method is terminated. Otherwise, the method returns to step 510.

Regarding step 570, while the embodiment of FIG. 5 shows that linking only is applied to negative results (i.e., a determination of non-compatible status), in other embodiments the linking can also be used for positive results (i.e., a determination of compatible status) so that the linked analytic solutions can avoid (bypass) the determination of step 560 on the merit of a first analytic solution from among a group of linked analytic solutions).

FIG. 6 shows still another exemplary method 600 for matching untagged data sources to untagged data analysis applications, in accordance with an embodiment of the present principles. It is to be appreciated that steps 610 are performed in a parallel manner in order to concurrently process the analytic solutions and determine matches and/or non-compatibility.

At step 610, move each of the analytics solutions (all of A1 through A6) from the repository 220 to the runtime platform 230.

At step 620, move each subset of the data in the data store 210 that corresponds to each of the analytics solutions to the runtime platform 230.

At step 630, execute the analytics solutions against the subsets of data.

At step 640, collect the execution logs generated by the analytics solutions, and analyze the log entries of each of the execution logs relevant to data compliance and compatibility.

At step 650, send the log analysis results to the analytics finder 250.

At step 660, determine, using the log analysis results, whether or not there is any error present in each of the results that is relevant to data compatibility (data access and data processing). If so, then the method proceeds to step 670. Otherwise, the method proceeds to step 680.

At step 670, record and report a non-compatible status for each of the implicated analytics solutions.

At step 680, record and report a match (a compatible status) for each of the implicated analytics solutions.

When declaring compatibility/non-compatibility, the analytics finder 250 can use one or more criterion. In an embodiment the analytics finder 250 can declare non-compatibility once it detects any error relevant to the data compliance issue. In another embodiment, the error symptoms are profiled a priori based on their severity, and critical errors (e.g., a predetermined severity level) are used to detect the non-compatibility. In yet another embodiment, all detected errors are analyzed, and non-compatibility is reported when the number of errors reaches a certain threshold.

FIGS. 7-9 show various methods for determining whether or not certain data (e.g., a data subset from data store 210) is compliant (e.g., with respect to access the data and processing the data) with one or more analytic solutions (e.g., one or more of A1 through A6 from the analytics repository 220), in accordance with various embodiments of the present principles. The method 700 of FIG. 7 will declare a non-compatible status between certain data and a particular analytic solution once any error relevant to data compliance is detected. For example, an access error and/or a processing error can be enough to declaration of a non-compliant status. The method 800 of FIG. 8 will declare a non-compliant status between certain data and a particular analytic solution only if the severity of one or more detected errors is above a threshold severity level. Thus, depending upon the implementation, one or more errors having a high severity level (as judged against, for example, the threshold severity level) can be used to arrive at a final status of non-compliance (no match) or compliance (match) for a particular analytic solution. The method 900 of FIG. 9 will declare a non-compliant status between certain data and a particular analytic solution when the number of detected errors for a given analytic solution is above a threshold number of errors. While shown as separate methods, it is to be appreciated that various aspects of methods 7-9, as well as methods 3-6, can be combined depending upon the particular implementation.

FIG. 7 shows a method 700 for determining whether or not data is compliant with one or more analytic solutions, in accordance with various embodiments of the present principles.

At step 710, it is determined whether or not any error relevant to data compatibility (data access and data processing) exists between certain data and a particular analytic solution. If so, then the method proceeds to step 720. Otherwise, the method proceeds to step 730.

At step 720, record and report a non-compatible status for the particular analytics solution.

At step 730, record and report a match (a compatible status) for the particular analytics solution.

FIG. 8 shows another method 800 for determining whether or not data is compliant with one or more analytic solutions, in accordance with various embodiments of the present principles.

At step 810, it is determined whether or not one or more errors exist relevant to data compatibility (data access and data processing) that have a severity above a predetermined severity threshold. If so, then the method proceeds to step 820. Otherwise, the method proceeds to step 830. In an embodiment, the severity can be determined a priori.

At step 820, record and report a non-compatible status for the particular analytics solution.

At step 830, record and report a match (a compatible status) for the particular analytics solution.

FIG. 9 shows yet another method 900 for determining whether or not data is compliant with one or more analytic solutions, in accordance with various embodiments of the present principles.

At step 910, it is determined whether or not the number of detected errors relevant to data compatibility (data access and data processing) between certain data and a particular analytic solution is above a threshold number of detected errors. If so, then the method proceeds to step 920. Otherwise, the method proceeds to step 930.

At step 920, record and report a non-compatible status for the particular analytics solution.

At step 930, record and report a match (a compatible status) for the particular analytics solution.

We now address ways in which the data that is compared to the analytic solutions is obtained, in accordance with various illustrative embodiments of the present principles. In an embodiment, the subset of the data is obtained by a sampling technique. For example, in an embodiment, the subset of data can be obtained as random samples from the data store 210. In another embodiment, the subset of the data set is obtained inherently by executing the analytics solution directly against the data in the data store 210 but for only a limited period of time. In yet another embodiment, the subset of the data is selected by a human. The preceding ways in which to obtain data to compare against analytic solutions is merely illustrative and, thus, other ways to obtain data can also be used in accordance with the teachings of the present principles, while maintaining the spirit of the present principles.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

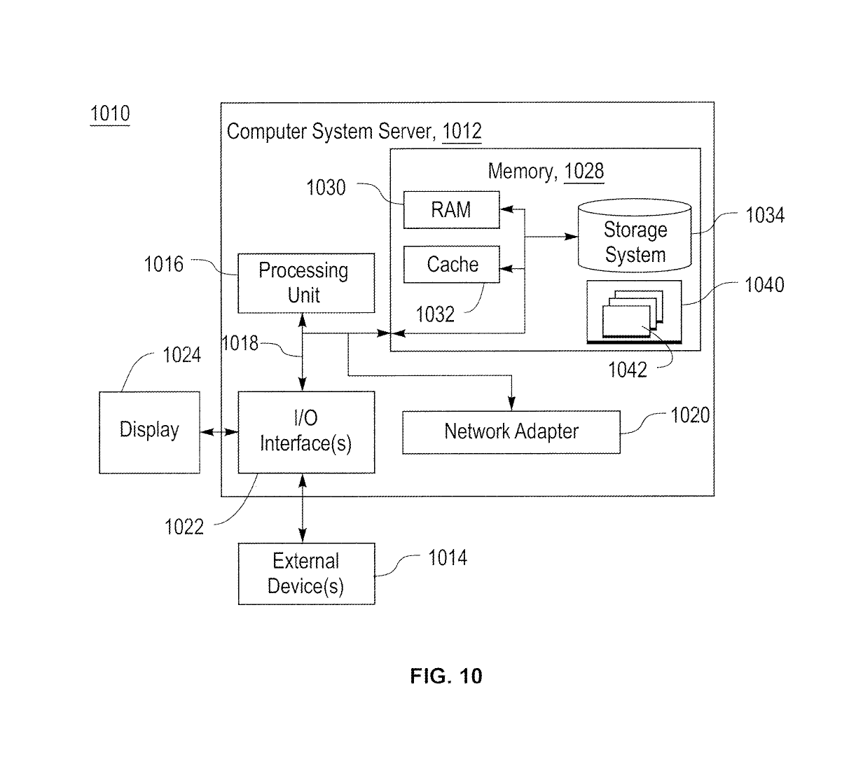

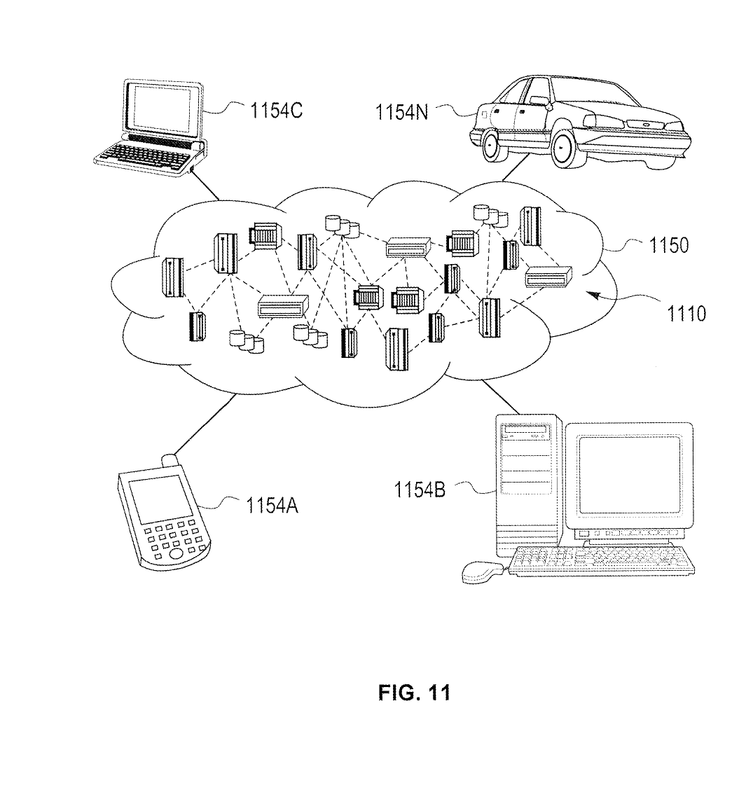

Referring now to FIG. 10, a schematic of an example of a cloud computing node 1010 is shown. Cloud computing node 1010 is only one example of a suitable cloud computing node and is not intended to suggest any limitation as to the scope of use or functionality of embodiments of the invention described herein. Regardless, cloud computing node 1010 is capable of being implemented and/or performing any of the functionality set forth hereinabove.

In cloud computing node 1010 there is a computer system/server 1012, which is operational with numerous other general purpose or special purpose computing system environments or configurations. Examples of well-known computing systems, environments, and/or configurations that may be suitable for use with computer system/server 1012 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 1012 may be described in the general context of computer system executable instructions, such as program modules, being executed by a computer system. Generally, program modules may include routines, programs, objects, components, logic, data structures, and so on that perform particular tasks or implement particular abstract data types. Computer system/server 1012 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 10, computer system/server 1012 in cloud computing node 1010 is shown in the form of a general-purpose computing device. The components of computer system/server 1012 may include, but are not limited to, one or more processors or processing units 1016, a system memory 1028, and a bus 1018 that couples various system components including system memory 1028 to processor 1016.

Bus 1018 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 1012 typically includes a variety of computer system readable media. Such media may be any available media that is accessible by computer system/server 1012, and it includes both volatile and non-volatile media, removable and non-removable media.

System memory 1028 can include computer system readable media in the form of volatile memory, such as random access memory (RAM) 1030 and/or cache memory 1032. Computer system/server 1012 may further include other removable/non-removable, volatile/non-volatile computer system storage media. By way of example only, storage system 1034 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 1018 by one or more data media interfaces. As will be further depicted and described below, memory 1028 may include at least one program product having a set (e.g., at least one) of program modules that are configured to carry out the functions of embodiments of the invention.

Program/utility 1040, having a set (at least one) of program modules 1042, may be stored in memory 1028 by way of example, and not limitation, as well as an operating system, one or more application programs, other program modules, and program data. Each of the operating system, one or more application programs, other program modules, and program data or some combination thereof, may include an implementation of a networking environment. Program modules 1042 generally carry out the functions and/or methodologies of embodiments of the invention as described herein.

Computer system/server 1012 may also communicate with one or more external devices 1014 such as a keyboard, a pointing device, a display 1024, etc.; one or more devices that enable a user to interact with computer system/server 1012; and/or any devices (e.g., network card, modem, etc.) that enable computer system/server 1012 to communicate with one or more other computing devices. Such communication can occur via Input/Output (I/O) interfaces 1022. Still yet, computer system/server 1012 can communicate with one or more networks such as a local area network (LAN), a general wide area network (WAN), and/or a public network (e.g., the Internet) via network adapter 1020. As depicted, network adapter 1020 communicates with the other components of computer system/server 1012 via bus 1018. It should be understood that although not shown, other hardware and/or software components could be used in conjunction with computer system/server 1012. Examples, include, but are not limited to: microcode, device drivers, redundant processing units, external disk drive arrays, RAID systems, tape drives, and data archival storage systems, etc.

Referring now to FIG. 11, illustrative cloud computing environment 1150 is depicted. As shown, cloud computing environment 1150 comprises one or more cloud computing nodes 1110 with which local computing devices used by cloud consumers, such as, for example, personal digital assistant (PDA) or cellular telephone 1154A, desktop computer 1154B, laptop computer 1154C, and/or automobile computer system 1154N may communicate. Nodes 1110 may communicate with one another. They may be grouped (not shown) physically or virtually, in one or more networks, such as Private, Community, Public, or Hybrid clouds as described hereinabove, or a combination thereof. This allows cloud computing environment 1150 to offer infrastructure, platforms and/or software as services for which a cloud consumer does not need to maintain resources on a local computing device. It is understood that the types of computing devices 1154A-N shown in FIG. 11 are intended to be illustrative only and that computing nodes 1110 and cloud computing environment 1150 can communicate with any type of computerized device over any type of network and/or network addressable connection (e.g., using a web browser).

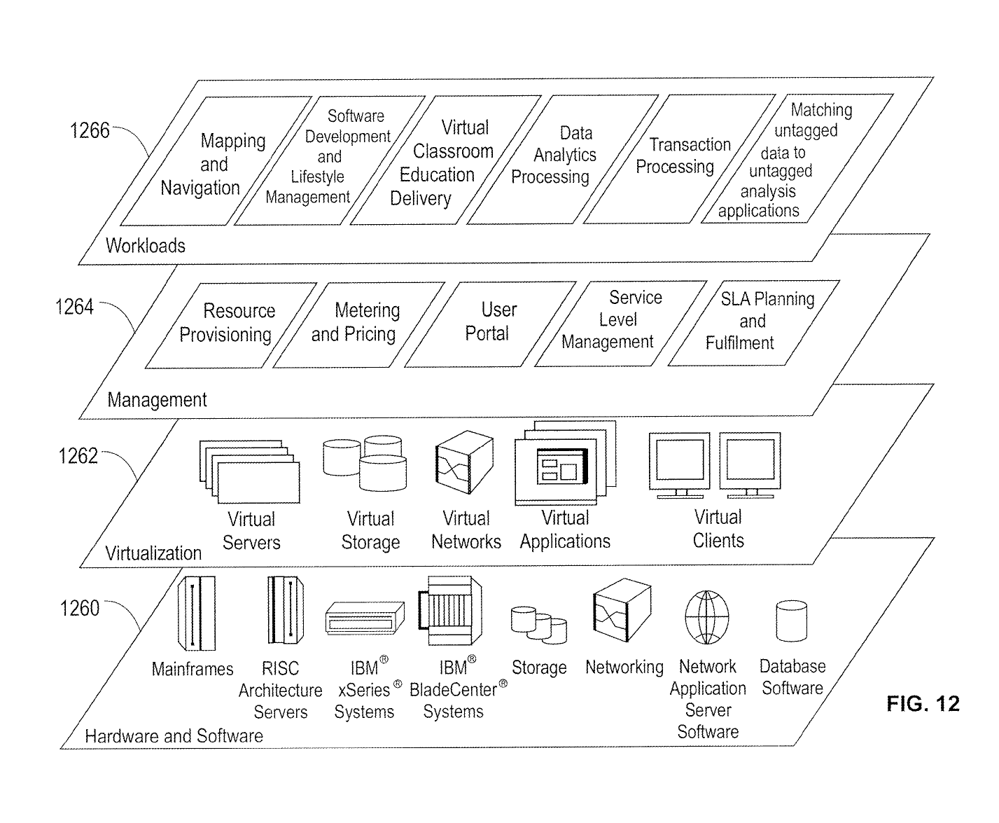

Referring now to FIG. 12, a set of functional abstraction layers provided by cloud computing environment 1150 (FIG. 11) is shown. It should be understood in advance that the components, layers, and functions shown in FIG. 12 are intended to be illustrative only and embodiments of the invention are not limited thereto. As depicted, the following layers and corresponding functions are provided:

Hardware and software layer 1260 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 1262 provides an abstraction layer from which the following examples of virtual entities may be provided: virtual servers; virtual storage; virtual networks, including virtual private networks; virtual applications and operating systems; and virtual clients.

In one example, management layer 1264 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 1266 provides examples of functionality for which the cloud computing environment may be utilized. Examples of workloads and functions which may be provided from this layer include: mapping and navigation; software development and lifecycle management; virtual classroom education delivery; data analytics processing; transaction processing; and matching untagged data sources to untagged data analysis applications.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method, comprising:
identifying a set of applications compatible with a set of data, wherein the applications and the data are untagged by corresponding metadata, wherein said identifying step comprises:
executing, by an execution platform, at least some of the applications in the set against at least some of the data in the set;
analyzing, by a log analyzer, execution logs for executions of the at least some of the applications against the at least some of the data; and
indicating, by the log analyzer, a compatibility of the at least some of the applications to the at least some of the data by detecting compatibility relevant errors using the execution logs.

2. The method of claim 1, wherein the executions of the at least some of the applications against the at least some of the data are performed sequentially.

3. The method of claim 2, wherein the method is terminated upon an indication of a compatibility status of a predetermined number of the at least some applications against corresponding portions of the at least some of the data.

4. The method of claim 3, wherein the predetermined number is an integer greater than one.

5. The method of claim 2, wherein a subset of the applications in the set are linked with respect to compatibility, and wherein an indication of incompatible status for a given one of the applications determined from a respective one of the executions is also applied to other ones of the applications linked in the subset without execution of the other ones of the applications.

6. The method of claim 5, wherein the applications in the subset are linked based on expected compatibility.

7. The method of claim 1, wherein the executions of the at least some of the applications against the at least some of the data are performed in parallel.

8. The method of claim 1, wherein said indicating step indicates an incompatible status for a given one of the applications with respect to a respective data portion responsive to detecting at least one compatibility error there between using a respective one of the execution logs.

9. The method of claim 1, wherein said indicating step indicates an incompatible status for a given one of the applications with respect to a respective data portion responsive to detecting a number of compatibility errors there between above a threshold using a respective one of the execution logs.

10. The method of claim 1, wherein said indicating step indicates an incompatible status for a given one of the applications with respect to a respective data portion responsive to detecting at least one compatibility error there between having a severity above a threshold using a respective one of the execution logs, wherein error severity is profiled a priori.

11. The method of claim 1, further comprising preventing any of the at least some of the applications that are indicated to have an incompatible status from being executed against a respective portion of the at least some data for which the indication is provided without modification intended to overcome the incompatible status.

12. The method of claim 1, further comprising selecting the at least some data from the set, against which the at least some applications are executed, using a sampling technique.

13. The method of claim 1, wherein the sampling technique involves obtaining random data samples.

14. The method of claim 1, further comprising selecting the at least some data from the set, against which the at least some applications are executed, using an execution time period limiting approach that inherently selects the at least some data by limiting an amount of overall execution time for the data in the set.
